(19) United States
(12) Patent Application Publication
(10) Pub. No.: US 2008/0048446 A1
(43) Pub. Date: Feb. 28, 2008

(54) Two-piece fitting and gasket assembly

(76) Inventor: Jon Houghton, Rochester Hills, MI (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/481,566

(22) Filed: Jul. 6, 2006

(51) Int. Cl. F16L 17/00

(52) U.S. Cl. 285/374

(57) ABSTRACT

There is provided a two-piece fitting and gasket assembly for telescopically receiving a tube such as a pipe. The assembly has a tubular, preferably cylindrical, body portion; a gasket retaining space defined by a wall on the body portion; a gasket housed within the gasket retaining space; and a retainer adapted for mounting over the wall and for retaining the gasket within the gasket retaining space. The gasket includes an annular ring portion, a sleeve portion extending radially inwardly from the annular ring portion and a further annular seal portion extending from the top end of the annular ring portion. The retainer has an interior leg and an exterior engaging leg. A retainer assembly is provided on the annular wall and the exterior engaging leg opposite the gasket. When the tube or pipe is received in the assembly, such that when pressurized, the gasket is compressed at a compression zone causing the wall to move radially outward and thereby further locking the retainer in place.

### FIELD OF THE INVENTION

The present invention relates to a two-piece fitting and gasket assembly for connecting tubes.

### BACKGROUND OF THE INVENTION

Plastic tubes or pipes and fittings are currently used extensively. A technique used for coupling the plastic pipe has been to brush a suitable solvent on one end of the pipe and then slip the pipe into a desired fitting. A problem with the solvent coupling technique is that the solvent must be brushed on and then after the coupling, a certain set-up or dry time is required until a proper seal is made.

Slip-in coupling assemblies have been used as an alternative to the solvent technique. In the use of a slip-in coupling, a pipe is inserted into the coupling assembly and an interference fit is caused between the outer diameter of the pipe and a flexible seal that forms part of the coupling assembly. One of the problems that exist with the slip-in coupling is that a lot of force is required to push the pipe into the coupling assembly and form the interference fit. The installer normally must lubricate the seal and manipulate the pipe until it finally slips into the coupling. These prior assemblies have caused the installers to spend excessive amounts of time and effort in making the connection between the pipe and coupling assembly.

Another problem exists when the plastic pipe is buried under ground as a drain or a sewer line. Applicable standards require that the slip-in coupling seal against a specified amount of exterior and interior pressure to prevent leakage. It has been difficult to maintain ease of installation and meet the required standards.

U.S. Pat. No. 4,174,859 discloses a two-piece pipe coupling assembly having a hub and a retainer ring. An elastomeric seal is held in place by the retainer ring. The coupling assembly is useful for fastening and sealing a pipe that is inserted into the assembly. The retainer ring has a contoured portion that aligns the pipe prior to its engagement with the seal. The seal has plural exterior, peripheral ribs that are compressed when the pipe is inserted and prevents leakage. Although these pipe assemblies have proven to be very successful, one problem encountered with them has been that the retainer ring may, on occasion, fall off the rest of the assembly. Various ways of keeping the retainer ring on the assembly, such as ultrasonic welding, gluing, etc., have been used, however, these all have disadvantages.

There, therefore, remains a need to provide a two-piece fitting and gasket assembly in which the opportunity for the retainer ring to fall off is minimized.

The disclosures of all patents/applications referenced herein are incorporated herein by reference.

### SUMMARY OF THE INVENTION

The invention herein relates to an assembly for fastening and sealing a tube, such as a pipe, that is inserted into the assembly. The assembly has three component parts: a tubular body portion, a retainer, and a flexible elastomeric gasket.

According to one aspect of the invention there is provided a two-piece fitting and gasket assembly for telescopically receiving a tube, the assembly comprising:
(a) a tubular body portion;
(b) a gasket retaining space located on the tubular body portion and defined by a wall having an interior face and an exterior face;
(c) a gasket housed within the gasket retaining space; and
(d) a retainer adapted for mounting over the wall and for retaining the gasket within the gasket retaining space, the retainer comprising:
   (i) a top retainer portion,
   (ii) an interior leg extending from the top retainer portion, and
   (iii) an exterior engaging leg extending from the top retainer portion and extending along the exterior face of the wall opposite the gasket,

wherein the exterior engaging leg of the retainer and the exterior face of the wall comprise a retaining assembly to lock the retainer in place.

In a preferred embodiment, the tube is a pipe, and the tubular body portion is cylindrical in shape. When the pipe is received in the assembly and when pressurized, the gasket is compressed at a compression zone causing the wall to be deflected outwardly, thereby further locking the retainer in place.

Numerous other objectives, advantages and features of the process will also become apparent to the person skilled in the art upon reading the detailed description of the preferred embodiments and the claims.

### BRIEF DESCRIPTION OF THE DRAWINGS

The preferred embodiments of the present invention will be described with reference to the accompanying drawings in which like numerals refer to the same parts in the several views and in which:

FIG. 1 is a perspective view of a preferred embodiment of the two-piece fitting and gasket assembly of the present invention;

FIG. 2 is a detailed cross-sectional view taken along lines 2-2 in FIG. 1; and

FIG. 3 is a cross-sectional view taken along lines 3-3 in FIG. 1.

### DETAILED DESCRIPTION OF THE PREFERRED EMBODIMENTS

The preferred embodiments of the present invention will now be described with reference to the accompanying figures.

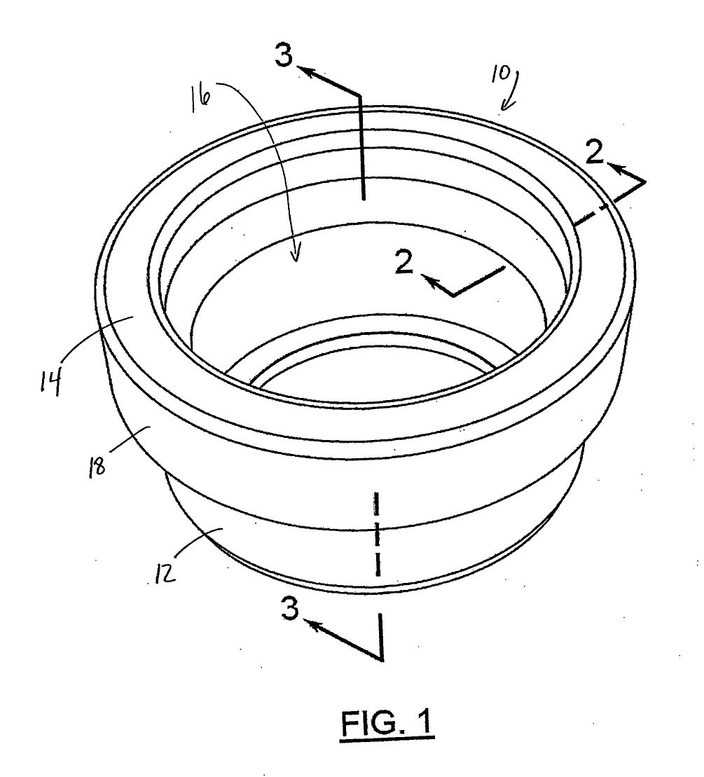

FIG. 1 illustrates one preferred embodiment of the two-piece fitting and gasket assembly 10 of the present invention. The assembly 10 comprises a tubular body portion 12, and a first end 14 defining an opening 16. Preferably, the tubular body portion 12 is cylindrical in shape. The assembly 10 also comprises a retainer 18 mounted over the first end 14. The retainer 18 is preferably in the general shape of a ring when the body portion 12 is cylindrical in shape. Opening 16 is adapted to telescopically receive an end of a tube or pipe (not shown). Preferably, the tube is a pipe when the body portion is cylindrical in shape. The assembly 10 of the present invention is the only required element in receiving, fastening and sealing a tube that is inserted into it.

The assembly 10 of the present invention may be incorporated into variously shaped couplings, such as Y-couplings as illustrated in U.S. Pat. No. 4,174,859. In addition the assembly 10 may also used on straight lengths of pipe.

In the following description of the assembly 10, a preferred embodiment is described in which the tube is a pipe, the tubular body portion 12 is cylindrical in shape, and the retainer 18 is in the general shape of a ring.

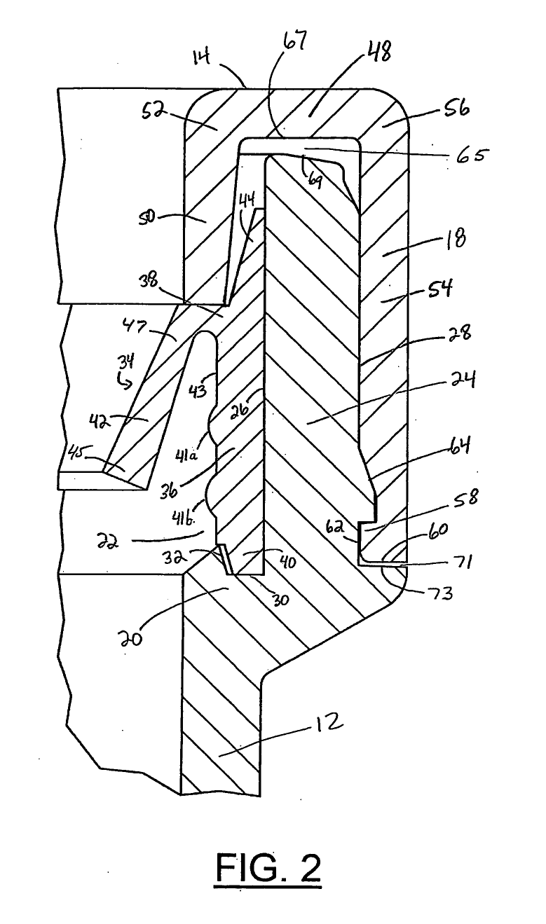

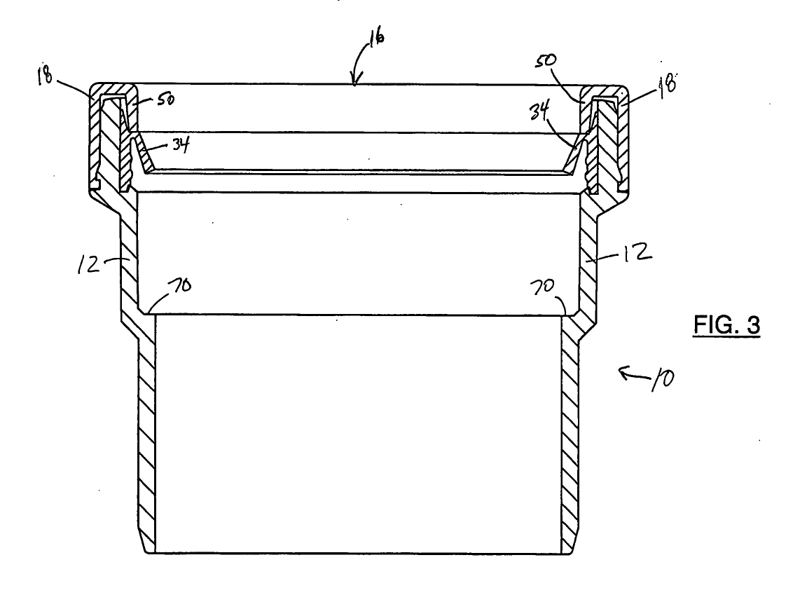

Referring to FIGS. 2 and 3, the assembly 10 of the present invention includes the body portion 12 having an end 20. Body portion 12 is preferably made of a rigid plastic material. A gasket retaining space 22 is located at the end 20 of the body portion 12. The gasket retaining space 22 is defined by a wall 24 having an interior face 26 and an exterior face 28. The gasket retaining space 22 also includes a pocket 30 located at the lower end of the gasket retaining space 22 and at the end 20 of the body portion 12. The pocket 30 is defined by a raised ledge 32 that is radially inwardly from interior face 26.

The assembly 10 further comprises a gasket 34 housed within the gasket retaining space 22. Gasket 34 is elastomeric. Preferably, the gasket is annular in shape when used in a cylindrical body portion. Gasket 34 includes an annular gasket portion 36 having a top end 38 and a bottom end 40, and preferably circumferential ribs 41a and 41b on the inside face 43 of the annular gasket portion 36. Bottom end 40 of the annular gasket portion 36 is received within the pocket 30. Gasket 34 also includes a sleeve portion 42 extending radially inwardly toward the axis of the body portion 12 from the annular gasket portion 36. Preferably, the sleeve portion 42 extends from the top end 38 of the annular gasket portion 36. Gasket 34 further comprises an annular top portion 44 extending from the top end 38 of the annular gasket portion 36.

In a preferred embodiment, far end 45 of sleeve portion 42 is thicker than the closer end 47. This feature allows the gasket 34 to create a better seal as will be explained in greater detail below. Further, gasket 34 is made from typical elastomeric material, such as EPDM and nitrile (a copolymer of butadiene and acrylonitrile). Gasket 34 preferably is made from a single elastomer and has an Elastomer Durometer in the range of about 45 to about 65, most preferably about 60 to about 65. As well, gasket 34 may have a dual elastomer construction, where the inside elastomer is relatively softer than the outside elastomer. In such a dual elastomer construction, the outside elastomer preferably has an Elastomer Durometer in the range of about 60 to about 80, and the inside elastomer preferably has an Elastomer Durometer in the range of about 40 to about 60, most preferably about 45.

The third component of the assembly 10 is a retainer 18 that is adapted for mounting over the wall 24 that defines the gasket retaining space 22. The retainer 18 is preferably made of a rigid plastic material and is adapted to retain the gasket 34 housed within the gasket retaining space 22. The retainer 18 has a generally inverted j-shape comprising a top retainer portion 48, which in the embodiment shown in FIG. 2 is a generally flat portion. However, it will be understand that top retainer portion 48 need not be shaped as shown in FIG. 2. Retainer 18 also comprises an interior leg 50 extending from the top retainer portion 48, preferably at an interior end 52, and over the further annular top portion 44 of the gasket 34. The retainer 18 also comprises an exterior engaging leg 54 extending from the top retainer portion 48, preferably at an exterior end 56. The exterior engaging leg 54 extends further than the interior leg 50 relative to the top retainer portion 48. In the preferred embodiment illustrated in FIGS. 2 and 3, the exterior engaging leg 54 extends down to the end 20 of the body portion 12, whereas the interior leg 50 extends down to only the top end 38 of the annular gasket portion 36 of the gasket 34. Therefore, the interior leg 50, the top retainer portion 48 and the exterior engaging leg 54 together define a generally j-shaped configuration, when viewed in cross-section.

The exterior engaging leg 54 together with the exterior face 28 further comprise a retaining assembly. In the preferred embodiment illustrated in FIGS. 2 and 3, the retaining assembly comprises a notch 58 disposed on exterior engaging leg 54. In the most preferred embodiment, notch 58 is located adjacent the far end 60 of the exterior engaging leg 54. The retaining assembly further comprises a groove 62 defined on the exterior face 28 of the annular wall 24. Notch 58 is adapted to mate within groove 62. A sloping wall portion 64 may also be provided on exterior face 28 that allows the notch 58 to slide over the sloping wall portion 64 before engaging the groove 62. Thus, in the embodiment of FIGS. 2 and 3, the retaining assembly comprises the notch 58, the groove 62 and the sloping wall portion 64, however, it will be appreciated that other configurations may be used to form the retaining assembly. As well, the retaining assembly need not be disposed adjacent the far end 60 of the exterior engaging leg 54. The retaining assembly may be located anywhere along the length of the exterior engaging leg 54, and most preferably it is located opposite the annular gasket portion 36. Thus, in the embodiment illustrated, the retaining assembly is disposed approximately opposite the bottom end 40 of the annular gasket portion 36. When the retainer 18 snaps into position, the retainer 18 is locked into position, and the gasket 34 is retained at both its bottom end 40 and at the annular top portion 44 thereby completing the assembly 10.

As shown in FIG. 2, when retainer 18 is placed in position, there is a first space 65 defined by the interior wall 67 and the top end 69 of the wall 24. A second space 71 is also formed between the far end 60 of the exterior engaging leg 54 and the ledge 73. The first space 65 allows the retainer 18 to move in response to any impact it may receive, thus minimizing the possibility of stress fractures to the retainer 18 upon impact. Second space 71 allows sufficient clearance for the far end 60 be received in the groove 62 when the retainer 18 is placed in position.

In use, when a tube or pipe is inserted into the opening 16 and received in the assembly 10, the tube or pipe compresses the sleeve portion 42 of the gasket 34 against the annular gasket portion 36. This compression of these parts of the gasket 34 occurs at a compression zone on the gasket 34. Generally, the compression zone is located at one or both of the circumferential ribs 41a and 41b, and in the embodiment where the sleeve portion 42 has a thicker far end 45, the compression zone will generally be located near the lower circumferential rib 41b. Further, it is also possible to make lower rib 41b bigger than upper rib 41a to ensure that the compression zone is created at the lower rib 41b. A further advantage to having a thicker far end 45 on the sleeve portion 42 is to create a better water impermeable seal when the tube or pipe is placed in the assembly 10.

When a tube or pipe is inserted into assembly 10, the creation of the compression zone in the gasket 34 will create a radially outward force against the wall 24. Thus, it will be seen that it is advantageous to have the retaining assembly located anywhere along the length of the exterior engaging leg 54, preferably it is located opposite the annular gasket portion 36, and most preferably the retaining assembly is located opposite the compression zone.

Thus, when a tube or pipe is inserted into assembly 10, the sleeve portion 42 of the gasket 34 acts to create a liquid impermeable seal between the outside wall of the tube and the gasket 34. As well, the radially outward force created by the compression of the sleeve portion 42 on the annular gasket portion 36 does at least three additional things. First, it assists in holding the pipe in the assembly 10. Second, the annular gasket portion 36 is compressed against the interior face 26 of the wall 24 thus creating a seal at the gasket/wall interface. Third, the compression creates a radially outward force that further locks the retainer 18 in place without the need of any extraneous material such as glue, solvents etc.

When assembly 10 is in use with a tube or pipe retained within it, a pressure is typically created in the interior space of the assembly 10. This pressure, in combination with gasket 34 that has annular gasket portion 36 and sleeve portion 42, will further assist in creating a better seal at the interface between the annular gasket portion 36 and the interior face 26. As well, the pressure creates a longitudinal force on gasket 34 towards the top end 38 of the annular gasket portion 36. This, in turn, pushes interior leg 50 of the retainer 18 in an upward longitudinal direction (upward being in the direction of the first end 14 of the assembly), thereby assisting in further locking the retainer 18 in position because notch 58 is caused to be held within groove 62. This pressure also creates a radially outward force causing wall 24 to deflect outward, thereby further locking the retainer 18.

The body portion 12 and the retainer 18 of the assembly 10 is preferably made of any suitable hard plastic, such as PVC, polypropylene, etc. PVC is the preferred material of construction used.

As seen in FIG. 3, the inside dimension of the body portion 12 (its diameter when body portion 12 is cylindrical in shape) is substantially identical to the inside dimension of the interior leg 50 of the retainer 18. The inside dimension of the body portion 12 and the retainer 18 is slightly greater than the outside dimension of the tube such that it allows the tube to be telescopically received within opening 16 of the assembly 10.

In the embodiment of the assembly 10 shown in FIG. 3, the tube or pipe can only be inserted into the assembly 10 until its end engages stop surface 70 on body portion 12.

Although the present invention has been shown and described with respect to its preferred embodiments, it will be understood by those skilled in the art that other changes, modifications, additions and omissions may be made without departing from the substance and the scope of the present invention as defined by the attached claims.

What is claimed is:

1. A two-piece fitting and gasket assembly for telescopically receiving a tube, the assembly comprising:
(a) a tubular body portion;
(b) a gasket retaining space located on the tubular body portion and defined by a wall having an interior face and an exterior face;
(c) a gasket housed within the gasket retaining space; and
(d) a retainer adapted for mounting over the wall and for retaining the gasket within the gasket retaining space, the retainer comprising:
i) a top retainer portion,
ii) an interior leg extending from the top retainer portion, and
iii) an exterior engaging leg extending from the top retainer portion and extending along the exterior face of the wall opposite the gasket,
wherein the exterior engaging leg of the retainer and the exterior face of the wall comprise a retaining assembly to lock the retainer in place.

2. The assembly of claim 1, wherein the tube is a pipe and the tubular body portion is cylindrical in shape.

3. The assembly of claim 2, such that when the assembly is pressurized, the gasket is compressed at a compression zone causing said wall to deflect outwardly, thereby further locking the retainer in place.

4. The assembly of claim 3, wherein the gasket comprises an annular ring portion and a sleeve portion extending radially inwardly from the annular ring portion.

5. The assembly of claim 4, wherein the annular ring portion of the gasket comprises at least one circumferential rib that engages with the sleeve portion when the pipe is received in the assembly to create the compression zone.

6. The assembly of claim 5, wherein the sleeve portion comprises a far end that is thicker relative to a closer end of the sleeve portion, and the far end engages with the circumferential rib.

7. The assembly of claim 3, wherein the gasket has an Elastomer Durometer in the range of from about 45 to about 65, most preferably about 60 to about 65.

8. The assembly of claim 3, wherein the gasket has a dual elastomer construction, where the outside elastomer has an Elastomer Durometer in the range of from about 60 to about 80, and the inside elastomer has an Elastomer Durometer in the range of from about 40 to about 60, most preferably about 45.

9. The assembly of claim 3, wherein the interior leg extends from an interior end of the top retainer portion, the exterior end extends from an exterior end of the top retainer portion, and the retaining assembly is located opposite the compression zone on the gasket.

10. The assembly of claim 3, wherein the retaining assembly comprises a notch on the exterior engaging leg that mates within a groove defined on the exterior face.

11. The assembly of claim 10, wherein the notch is located at the end of the exterior engaging leg.

12. The assembly of claim 3, wherein the body portion and the retainer each have an inside diameter that allows the pipe to be received within the assembly.

13. The assembly of claim 4, wherein the gasket retaining space comprises a pocket for receiving the bottom end of the annular ring portion.

14. The assembly of claim 3, wherein the body portion includes a stop surface to prevent further insertion of the pipe into the assembly.

15. The assembly of claim 3, in which the body portion and retainer are made of rigid plastic material and the gasket is made of elastomeric material.

16. The assembly of claim 1, wherein the gasket has an Elastomer Durometer in the range of from about 45 to about 65, most preferably about 60 to about 65.

17. The assembly of claim 1, wherein the gasket has a dual elastomer construction, where the outside elastomer has an Elastomer Durometer in the range of from about 60 to about 80, and the inside elastomer has an Elastomer Durometer in the range of from about 40 to about 60, most preferably about 45.

18. The assembly of claim 1, such that when the assembly is pressurized, the gasket is compressed at a compression zone causing said wall to deflect outwardly, thereby further locking the retainer in place.

19. The assembly of claim 18, wherein the interior leg extends from an interior end of the top retainer portion, the exterior end extends from an exterior end of the top retainer portion, and the retaining assembly is located opposite the compression zone on the gasket.

20. The assembly of claim 19, wherein the retaining assembly comprises a notch on the exterior engaging leg that mates within a groove defined on the exterior face.

21. The assembly of claim 20, wherein the notch is located at the end of the exterior engaging leg.

22. The assembly of claim 1, wherein the body portion and the retainer each have an inside dimension that allows the tube to be received within the assembly.

23. The assembly of claim 1, wherein the gasket retaining space comprises a pocket for receiving a bottom end of the gasket.

24. The assembly of claim 1, wherein the body portion includes a stop surface to prevent further insertion of the tube into the assembly.

25. The assembly of claim 1, in which the body portion and retainer are made of rigid plastic material and the gasket is made of elastomeric material.
